(19) United States
(12) Patent Application Publication
(10) Pub. No.: US 2023/0306404 A1
(43) Pub. Date: Sep. 28, 2023

(54) Dynamic Selection of Processing Devices in a Multi-Device Network

(71) Applicant: Bank of America Corporation, Charlotte, NC (US)

(72) Inventors: Puneetha Polasa, Telangana (IN); Bhagya Lakshmi Sudha Lavanya Mallidi, Hyderabad (IN); Udaya Kumar Raju Ratnakaram, Hyderabad (IN); Sandeep Kumar Chauhan, Hyderabad (IN)

(21) Appl. No.: 17/702,460

(22) Filed: Mar. 23, 2022

(51) Int. Cl. G06Q 20/32; G06Q 20/06

(52) U.S. Cl. CPC G06Q 20/3224; G06Q 20/3263; G06Q 20/065

(57) ABSTRACT

A method and apparatus for dynamically selecting a transaction processing device in a multi-device network is provided. A transaction processing device may be used to generate, approve, execute, and otherwise process transactions for devices in the multi-device network. A device selection platform may determine which of a plurality of devices is to serve as the transaction processing device based on a variety of factors such as battery life, processing power, communication connectivity, storage capacity and the like. The devices may be prioritized and ranked based on these factors. The platform may further monitor for changes in the network and dynamically update the prioritization and ranking and/or selection of the transaction processing device.

### BACKGROUND

Aspects of the disclosure relate to electrical computers, systems, and devices for interconnecting devices through a network, and dynamic and automated device polling and selection for transaction processing.

Users make a multitude of transactions on a daily basis. From groceries to gas to household items to in-app purchases, users spend significant time swiping, hovering, scanning or entering payment devices and information (e.g., a credit card number, a payment account handle/username, or a QR code). These payments may include processes such as one-time payments and/or means of enhancing payment security. These collective transactions requiring user participation and attention are time-consuming and often distract from other tasks in the user's life.

With the advent of Internet of Things (IoT) environments, devices have become smart enough to communicate with one another and with external networks to convey various types of data. In some instances, IoT devices may be used to initiate transactions for some associated item (e.g., gas for a vehicle, dish detergent for a dishwasher, laundry detergent pods for a washing machine, or coffee for a coffee maker). These transactions are typically facilitated through an authorized payment processing device that is manually selected and/or configured by a user. However, since the devices within an IoT network may change (e.g., a mobile device may leave the house), a user might need to manually reconfigure the payment processing configuration of the IoT network to identify a new authorized payment processing device. This requires further attention and time from the user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some aspects, a polling process may be executed to determine attributes of devices within a network. For instance, devices in the network may be polled to obtain information such as device battery level, device processing power, memory capacity, network connectivity and other attributes or characteristics. Other information collected during the polling process may include identification information such as name, model, network identifier, device type and the like.

In some aspects, a device ranking or priority may be determined. For example, the information obtained through the polling process may be used to rank or order the devices in the network in order of priority. The ranking may be performed automatically and based a predefined schedule and/or based on triggering events and conditions.

In some instances, a device selection process may be performed to select a device in a network for transaction processing responsibilities. The selected device may be responsible for facilitating and executing all transaction requests from devices in the network. This transaction device selection process may use a ranking or priority of the devices. This ranking or priority may be determined based on polled information. In some examples, multiple transaction devices may be assigned.

In further aspects, a request to process or initiate a transaction may be received. In some examples, the request may be received from one of the devices in the network. A transaction processing device may obtain the transaction request information and process the transaction request through one or more payment channels and a corresponding merchant. A confirmation that the transaction was processed may be provided to the requesting device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing dynamic device selection functions in accordance with one or more aspects described herein;

FIG. 2 is a flowchart illustrating an example method for performing dynamic polling and device selection according to one or more aspects described herein;

FIG. 3 illustrates an example device selection and transaction process flow according to one or more aspects described herein;

FIG. 4 is a flowchart illustrating an example method for performing device selection and executing a transaction according to one or more aspects described herein;

FIG. 5 illustrates an example packet structure for communications between devices in a network according to one or more aspects described herein; and

FIG. 6 illustrates an example computing system environment for transaction processing and device selection according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, many devices have now been configured to have network connectivity and/or smart features to allow inter-device communication. According to aspects described herein, one or more such devices may, for example, automatically initiate transactions to alleviate users from having to manually monitor personal, business, and/or household needs. In some instances, selecting a device within the network to process all transaction requests may improve communication and processing efficiency.

For instance, a device in a home Internet of Things (IoT) network may include a coffee maker. The coffee maker may include processing elements that allow for it to determine when additional coffee pods, grinds or beans are needed. The coffee maker may be connected to a variety of other devices in the IoT network including other home appliances, vehicles, personal communication devices and the like.

In the network, one or more of the devices may be selected to perform transaction processing. Accordingly, when the coffee maker initiates a request to purchase additional coffee pods, that transaction request may be sent to a designated device (or devices) that may then process the transaction through a payment channel and vendor or merchant.

To select the transaction processing device (or devices), a system may first poll devices in the network to obtain device information. Based on the collected device information, the devices in the network may be ranked or prioritized based on the needs or requirements of a transaction processing device. For example, transaction processing may require certain types of network connectivity, battery power backup, certain memory capacity, a threshold processing power or available processing power, and the like and/or combinations thereof. One or more devices may then be selected based on this prioritization and ranking.

The system may further monitor the availability of the selected transaction device(s) to ensure uninterrupted transaction processing servicing. When a selected transaction processing device is determined to be unavailable, the system may select a new device to serve the transaction processing role for the network. In some examples, the system may perform the polling, ranking, and selection processes again upon detecting the unavailability of the previously selected transaction device. Additionally, or alternatively, devices in the network may be polled and/or ranked periodically, based on a triggering condition or event, and the like.

These and various other arrangements will be discussed more fully below.

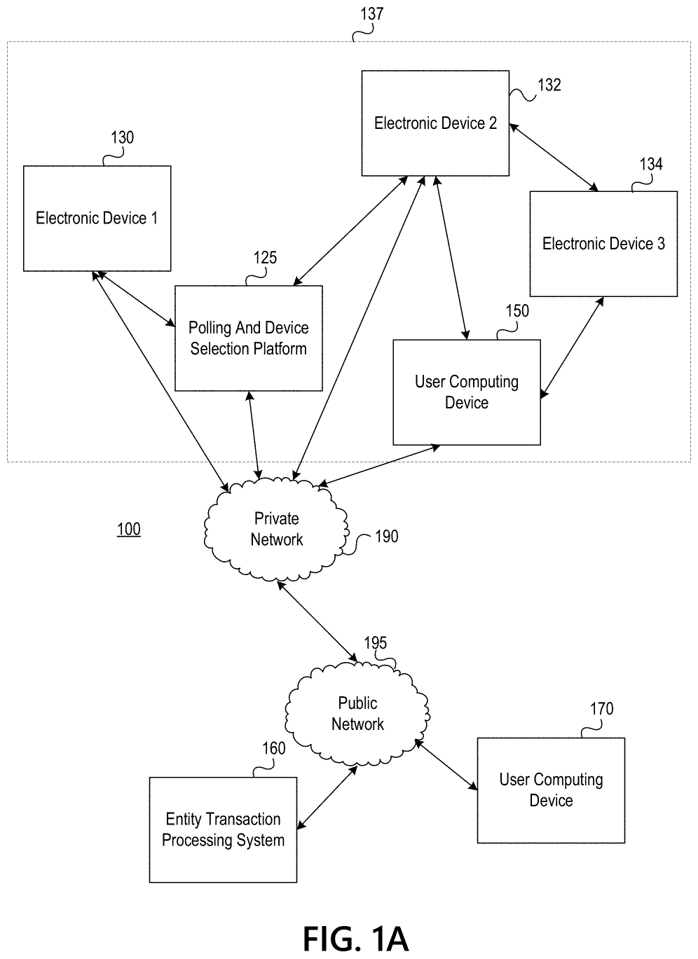

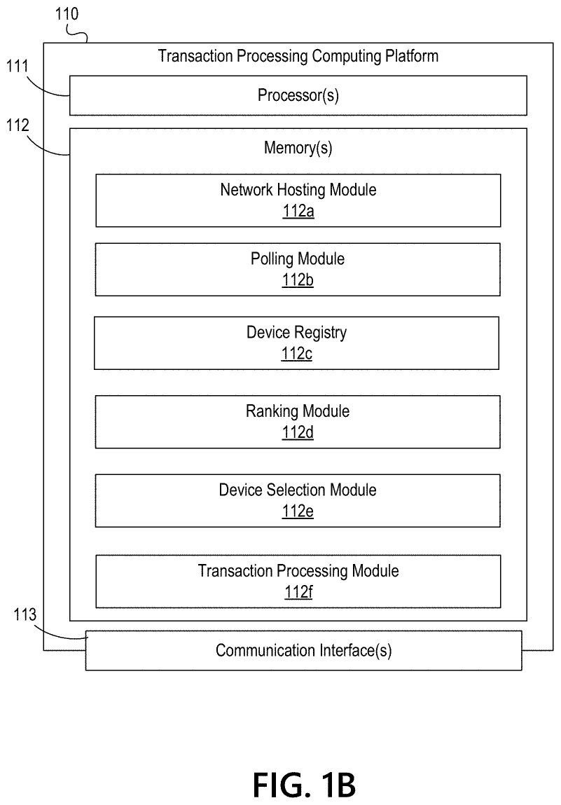

FIGS. 1A and 1B depict an illustrative computing environment for implementing and using dynamic device selection and transaction processing functions in accordance with one or more aspects described herein. Referring to FIG. 1A, computing environment 100 may include one or more computing and electronic devices and/or other computing systems connected through one or more networks. For example, computing environment 100 may include a polling and device selection platform 125, user computing devices 150 and 170, other electronic devices 130, 132, and 134, and an entity transaction processing system 160. Electronic devices 130, 132, and 134 may include computing devices such as laptops, mobile phones, smartphones, tablets, as well as electronic appliances such as refrigerators, washing machines, dryers, lighting devices, stoves, ovens, microwaves, and the like, and other electronic devices such as vehicles. Such devices may also include processors and communication interfaces with which the devices 130, 132, and 134 may execute instructions and communicate with each other and/or other devices. While the illustration of FIG. 1A includes particular numbers of devices, any number of systems or devices may be used without departing from the aspects described herein.

As mentioned above, computing environment 100 also may include one or more networks, which may interconnect one or more of the polling and device selection platform 125, electronic devices 130, 132, 134, user computing devices 150, 170 and entity transaction processing system 160. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular user, location (e.g., home, office), and/or organization (e.g., a corporation, financial institution, educational institution, governmental institution, or the like) and may interconnect one or more computing devices associated with the user, location and/or organization. For example, private network 190 may be a user-configured home network that interconnects one or more of the devices at the user's home or otherwise associated with the user. This may include polling and device selection platform 125, user computing device 150, and electronic devices 130, 132, and 34. In one or more examples, a device such as electronic device 134 may connect to the private network 190 through another device such as user computing device 150. Additionally, or alternatively, devices may connect directly to one another using various communication technologies and protocols including Bluetooth, NFC, infrared and the like. In an example, device 134 may be connected to computing device 150 using Bluetooth. The private network 190 may further provide access to a public network such as the Internet or another wide-area network (WAN) and devices external to the private network 190, including entity transaction processing system 160 and user computing device 170.

According to aspects described herein, one or more devices within the private network 190 may form a sub-network. In FIG. 1A, for example, polling and device selection platform 125, user computing device 150 and electronic devices 130, 132, and 134 collectively form a sub-network 137 of devices. A sub-network 137 may be hosted by one or more of the devices (e.g., platform 125 and/or user computing device 150) and use a particular network protocol. In one example, sub-network 137 may be an Internet of Things (IoT) network that allows electronic devices 130, 132, 134 to communicate with one another, with polling and device selection platform 125 and user computing device 150, and with external devices on the public network 195. This communication may include reporting usage data or performance information such as operating time of a washing machine, energy usage of a refrigerator, error reporting, temperature of an oven, user presence in the location, motion detection, security information, remaining gas and/or gas usage of a vehicle and the like. Device communications may also include transaction requests such as requesting the purchase of a consumable item or requesting a subscription to a service or product. For a vehicle, a consumable may be gas or wiper fluid, while for a consumable item for a dryer may include fabric softener. In other examples, a refrigerator may indicate when a water filter needs to be purchased while a washing machine may indicate when more detergent is to be purchased. In some instances, network 137 may be a separate network from private network 190 (rather than a sub-network). In such an arrangement, the separate network would use one of the devices within that network to connect to private network 190 and/or to public network 195.

Within network 137, it may be that designating one or more devices within the sub-network 137 to facilitate transactions provides more efficiency in network communications as well as transaction security. Accordingly, a system such as polling and device selection platform 125 may be configured to select one of the devices within network 137 to perform a transaction processing role. In one example, polling and device selection platform 125 may be configured to provide intelligent, dynamic, and efficient identification of devices in network 137 and device attributes, evaluation of device capabilities, and selection of one or more of the devices in network 137 to act as a transaction processing device. To identify devices in network 137, polling and device selection platform 125 may be configured to host or otherwise manage network 137, including its membership. When a new device wishes to join network 137, the device may be directed to polling and device selection platform 125 to receive authorization and network details. Once information about the new device is received or otherwise determined, the polling and device selection platform 125 may determine whether to approve the new device joining network 137. In some examples, this may require the new device to provide authentication information, such as a password or token specific to network 137 or to a user associated with network 137. If the new device is approved for membership, the new device information may be stored to a device registry storing device information of all member devices of network 137. The polling and device selection platform 125 may further provide connection and/or protocol information (e.g., packet structure, network-specific header information, security requirements (e.g., encryption protocols), information for the other devices, and the like) to the new device so that it is able to communicate with other devices within network 137.

Upon a new device joining the network, platform 125 may send out polling requests to identify and obtain information about the device within network 137. Polling may include obtaining device attribute information such as processing power, processing load, storage capacity, battery level, battery capacity, and the like. In some instances, this polling may also indicate whether a device still exists within network 137. For example, if platform 125 polls electronic device 134 and either receives a communication rejection message or receives no response, platform 125 may determine that electronic device 134 is no longer part of network 137 and update the device registry or other network membership record accordingly. Additionally, platform 125 may inform each of the other devices 130, 132, and 150 in network 137 of the updated membership of network 137. In some arrangements, devices within network 137 may proactively transmit device attributes and information to platform 125 based on a triggering event or based on a specified schedule. Triggering events may include when a processing load of the device changes by more than some percentage threshold, when an amount of remaining battery changes by more than some percentage amount, when a remaining amount of battery drops below a certain threshold percentage, when a memory capacity of the device changes by a percentage amount or decreases below a threshold amount, and the like and/or combinations thereof. Alternatively, or additionally, devices within network 137 may report device information every 30 seconds, every 5 minutes, every 30 minutes, every hour and the like. Other reporting schedules and triggers may be defined as needed or desired.

When providing transaction processing within network 137, the polling and device selection platform 125 may be configured to select one of devices 130, 132, 134, and 150 to act as a transaction processing hub or facilitating device. This selection may involve polling and device selection platform 125 ranking or prioritizing devices 130, 132, 134, and 150 and selecting the highest ranking or highest priority device as the transaction processing hub. Prioritization and ranking may be performed using a variety of algorithms. In one example, platform 125 may use the device information received from the polling process. Accordingly, devices 130, 132, 134, and may be ranked based on an amount of processing power available, an amount of battery life remaining, whether the device has battery back-up (e.g., for a plugged-in device), an amount of storage capacity available, network connectivity (e.g., whether the device is connected to the public network) and the like and/or combinations thereof. In some cases, multiple transaction processing devices may be selected to divide the transaction processing load. For example, platform 125 may designate a transaction processing device for each of devices 130 and 132 and a different transaction processing device for devices 134 and 150.

Once the transaction processing device has been selected, each of devices 130, 132, 134, and 150 may be informed of the selection so that those devices direct transaction requests to the selected device. In some examples, platform 125 may remain a facilitating intermediary which receives all transaction requests from devices and forwards them to the selected transaction processing device. In this case, the transaction processing device selection might not be communicated to every device in network 137.

Transactions initiated by a device in network 137 may be communicated to an external transaction processing system such as entity transaction processing system 160 by the selected transaction processing device. Entity transaction processing system 160 may be or include one or more computing devices or systems associated with entities external to the user's network 190 such as a financial institution or a payment network. For example, entity transaction processing system 160 may be associated with an organization that provides one or more user accounts or payment devices (e.g., debit card, credit card, bank account, or the like). In some examples, multiple entity transaction processing systems may exist corresponding to different user accounts and/or payment devices.

Further, user computing device 170 may be a device associated with the user that is currently operating outside of private network 190. User computing device 170 may be used to interface with one or more devices in private network 190 or network 137 from outside of the user's private network 190. For example, a user may operate computing device 170 to manually select a transaction processing device for network 137. In another example, a user may use computing device 170 to modify the selection algorithm (e.g., ranking rules, weights for ranking factors, etc.) for selecting the transaction processing device. In yet another example, a user may use computing device 170 to join and/or approve new devices to network 137. User computing device 170 may also be used to initiate transactions through one or more devices in network 137. Similar functions may be available through any of the devices in network 137 as well.

Referring to FIG. 1B, polling and device selection platform 110 may include one or more processors 111, memory 112, and communication interface 113. A data bus may interconnect processor(s) 111, memory 112, and communication interface 113. Communication interface 113 may be a network interface configured to support communication between polling and device selection platform 110 and one or more networks (e.g., private network 190, public network 195, or the like). Memory 112 may include one or more program modules having instructions that when executed by processor(s) 111 cause polling and device selection platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of polling and device selection platform 110 and/or by different computing devices that may form and/or otherwise make up polling and device selection platform 110.

For example, memory 112 may have, store and/or include network hosting module 112a. Network hosting module 112a may store instructions and/or data that may cause or enable the polling and device selection platform 110 to manage a network of devices (e.g., an IoT network, a home-based local area network of devices, etc.) including monitoring membership, authorizing devices to join the network, facilitating communications between devices, specifying configuration and protocol parameters and the like. For example, network hosting module 112a may store rules for forwarding or filtering communications between devices, for setting permissions on device actions, for controlling reporting by the devices in the network (e.g., network 137) and the like.

Polling and device selection platform 110 may further have, store and/or include polling module 112b. Polling module 112b may store instructions and/or data that may cause or enable the polling and device selection platform 110 to obtain information about each device in network 137 and to identify networks that may want to join network 137. For example, polling module 112b may include instructions for transmitting a signal to one or more devices, requesting certain information about those devices. In some instances, that signal may be transmitted to known devices. In other instances, the signal may be transmitted within a physical range (e.g., 10 feet, 100 feet, 250 feet, 500 feet, etc.). Polling module 112b may also store instructions for controlling a frequency and schedule of when devices are polled. This may also include triggering rules or events for executing the polling process.

Device registry 112c may be configured to store device information and identify device membership within the network (e.g., network 137). For example, device registry 112c may store information such as a device identifier (e.g., device name, a username for a user associated with the device, etc.), a network identifier (e.g., IP address, MAC address, etc.), device model and the like. The device registry may be accessible to all devices in the network, or might only be accessible to platform 110. In some instances, platform 110 may grant access to a subset of devices in network 137 and/or to devices not in the network 137 (e.g., user device 170). In some instances, device registry 112c may also store information identifying the device (or devices) selected to be the transaction processing device for network 137.

Ranking module 112d may be used in conjunction with device selection module 112e to prioritize devices in network 137 and to subsequently select one of the devices to act as a transaction processing hub, respectively. Ranking module 112d may use information obtained through the polling module 112b and stored in device registry 112c to determine a priority or ranking for each device for the transaction processing role within network 137. Based on this prioritization, device selection module 112e may determine one or more of the devices to serve as the transaction processing hub and communicate that information to devices in network 137. Device selection module 112e may further store this selection information in device registry 112c or another storage portion of the memory 112. In some instances, device selection module 112e may also interface with network hosting module 112a to direct transaction request traffic from devices in network 137 to the selected transaction processing hub or device.

In some examples, the polling and device selection platform 110 may further serve as a transaction processing hub. Accordingly, polling and device selection platform 110 may further have, store and/or include transaction processing module 112f. Transaction processing module 112f may be configured to authorize transactions and transmit those transactions through a payment channel. For example, transaction processing module 112f may determine whether a transaction is within a specified spending limit or if the type of transaction is allowed based on user-configurable rules and/or intelligent machine learning algorithms. Transaction processing module 112f may store instructions and/or data that may cause or enable the platform 110 to generate and transmit one or more instructions to one or more merchant systems to process the transaction, generate and transmit one or more instructions to modify an account or ledger, or the like. Transaction processing module 112f may also perform authentication processes to generate a request for authentication data from a user or to request authentication (e.g., of a transaction-initiating user) and transmit the request to a device, such as entity transaction processing device 170 or another authentication server (not shown). The authentication data requested may be data associated with a payment device selected by the user from the dynamic rendering displayed on a display of the device. The user may input authentication response data which may be received by the authentication module 112f and processed. Transaction processing module 112f may subsequent communicate whether a user or transaction has been authenticated.

As discussed, according to one or more aspects, a device selection platform may facilitate the establishment and operation of a network such as an IoT network. The network may be defined by a particular protocol and use various types of wired and wireless communication schemes including BLUETOOTH, Wi-Fi, ZigBee, PowerLine, Ethernet, NFC and the like and/or combinations thereof. In some arrangements, when a new device wishes to join the network, it may send a request or polling communication to the host and/or other devices already in the network. Alternatively, or additionally, an existing device in the network may detect that a new device is within range and send a polling request or other communication to the new device. Polling may include a request for information about the device being polled. In some instances, polling may include information about the device sending the polling communication.

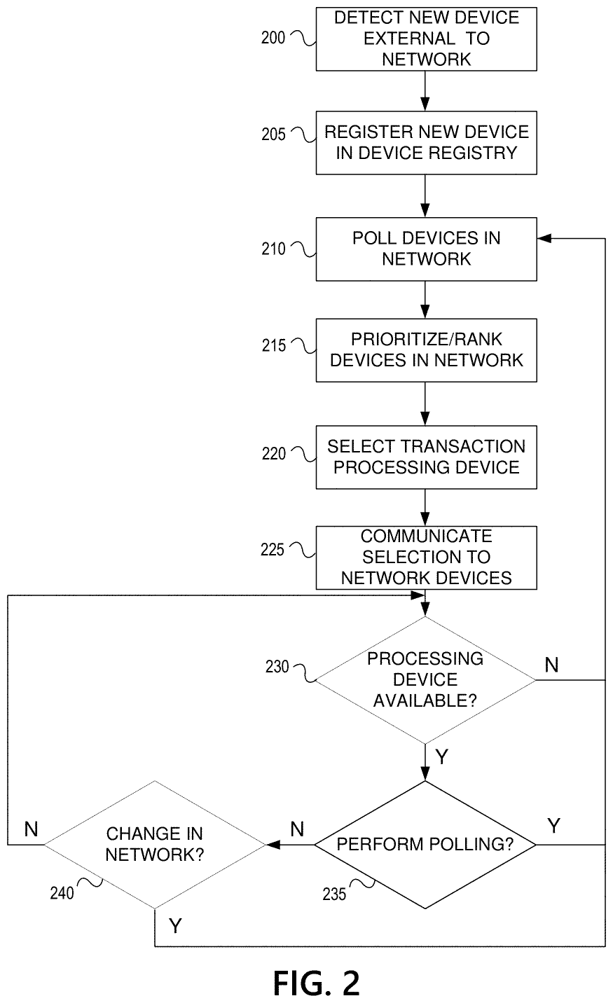

FIG. 2 is a flowchart illustrating a process for managing a network of devices and selecting one or more of those devices for transaction processing. In step 200, a polling and device selection platform such as platform 110 (FIG. 1B) may detect a new device that is not currently part of the network. In one example, the platform may detect this new device when the new device indicates a desire to join the network (e.g., by sending a join request or similar communication). In another example, the platform may detect this new device by periodically broadcasting a message with connection information. A new device may respond to this message indicating a desire to join or otherwise confirming receipt of the broadcast. When the new device sends a request to the platform to join the network, the new device may provide device information along with the request. This device information may include a variety of parameters including a device ID, device name, network ID, device type, device model and the like. Additionally, or alternatively, the request may include device characteristics such as processing power, processing load, battery level, battery capacity, existence of battery back-up, memory capacity, network connectivity, communication capabilities and the like. In one or more arrangements, the platform may indicate required information that must be provided when a new device indicates a desire to join the network. For example, this indication may be provided in an initial broadcast message. The required information may be user configurable.

In step 205, the host system or device (e.g., the polling and device selection platform) may register the new device information in a device registry or other information storage upon accepting or approving the new device's request to join the network. Registration may include determining and storing device information such as a device identifier (e.g., MAC address, user-specified name, etc.), model name or number of the device, network identifier (e.g., an IP address), and the like. For example, the device information may be determined from the device's request to join the network. Alternatively, or additionally, the platform may request information from the device upon receiving the device's request to join. In some examples, some device information may be provided as part of the request. Upon the platform determining, based on the information provided, that additional information is needed, the platform may further request and receive that information from the new device.

Once the new device has been registered and added to the network, the platform may perform a polling process in step 210. For example, the platform may poll each device in the network to obtain certain information. This information may include device-specific attributes such as battery level, processing load, processing capabilities, connectivity information, local cache size, storage availability and the like. For example, battery level may indicate an amount of remaining power the device has. The battery level may be expressed as a percentage remaining and/or an amount of time (e.g., estimated) that the device can operate with the remaining amount of battery. In other examples, the information may indicate whether the device has battery backup or not. Processing capabilities may refer to the processing power of the device (e.g., CPU speed, amount of RAM, etc.) while the processing load may indicate how much of the device's processing power is currently being used. Connectivity information may indicate whether a device is connected to a wide area network such as the Internet or whether the device is only connected to the local network. This may dictate whether the device can act as a transaction processing device since such a device would likely need to have wide area network connectivity to authorize and complete transactions through a payment channel. Connectivity information may also include communication and/or security protocol capabilities. Further, local cache size and storage availability may indicate an amount of storage space available to the network of devices for storing (temporarily or on a longer-term basis) transaction information. In one example, the cache or memory of the transaction device may be tasked with storing a transaction history including a source device identifier, transaction type, merchant, transaction amount, date and/or time, and the like.

Additionally, or alternatively, the platform may obtain behavior history of the device from the polled devices. The behavior history may indicate a pattern of when processing load increases or decreases above or below a particular threshold, patterns of when a device might typically join or leave the network, patterns of when a device is typically plugged-in to a power source, history of battery usage, history of storage usage and the like. In some examples, the platform may also determine such behavior based on its own knowledge base that tracks device attributes over time.

In some arrangements, the platform might only poll those devices that have not provided information within a specified period of time. For example, the platform might only poll those devices that have not reported data in the last 5 minutes, or 10 minutes, or 1 hour, or other time period. In another example, the platform might only poll those devices that meet a predefined condition based on the most recently reported device information. Such conditions may include having a battery level below 50% or having a processing load that is higher than 50% of its maximum processing power or having a memory capacity less than 30%. In yet other examples, the platform might only poll those devices that have transaction processing capabilities (e.g., network connectivity to a public network, secure communication protocols, etc.). A variety of conditions or combinations of conditions may be defined as needed or desired.

In step 215, based on the results of the polling, the platform may further determine a priority or ranking for each of the network devices based on the device attributes and information. One or more priority or ranking algorithms may be applied. In one example, the ranking may weigh each of a variety of factors, such as those described above, and subsequently generate a ranking score. More particularly, the ranking process may rank each of the devices based on each factor. In an example, the device with the highest processing speed may be given a 1 ranking for that factor. The device with the lowest processing load may be given a 1 ranking for that factor, and so on. Each of these rankings may be weighed, and subsequently combined (e.g., added, multiplied, etc.). The devices may then be ranked based on the total ranking value, with the lowest total ranking the highest (i.e., having the highest priority) and the highest total ranking the lowest (i.e., having the lowest priority). The platform may then select one of the devices as the transaction processing device for the network in step 220 based on the ranking and prioritization. For example, the platform may select the highest ranked or highest prioritized device as the transaction processing device through which all (or one or more) of the other devices in the network initiate and request transactions. In some arrangements, the platform may select more than one transaction processing device based on the ranking. The number of transaction processing devices may be user configurable or may be defined as a default system setting. In some instances, the number of transaction processing devices may be defined based on a current or expected transaction processing load. For example, the platform may consider how many transactions have occurred in the last hour or 12 hours or 24 hours, and/or look at historical data to see how many transactions have occurred during similar time periods. Further, the platform may base the ranking or prioritization based on historical information either obtained from the device or managed/stored by the platform itself. As noted previously, the platform may host a knowledge base of information that provides device history and behavioral patterns. Additionally, or alternatively, the platform may select one device for a set period of time, and another device for another period of time. The selected devices may then automatically switch over to serve as the transaction processing device at their respective assigned times.

In some arrangements, the platform may consider whether a device is capable of processing transactions as an initial filter for the ranking algorithm. A device may be considered incapable of processing a transaction if it does not have the requisite software, security, hardware, or network connectivity to complete a transaction. For example, if a device is unable to connect with a particular payment provider (e.g., a financial institution), that device may be considered incapable of processing a transaction. In another example, a device may need to have specialized software, hardware or security protocols to securely execute transactions with one or more payment channels. Accordingly, a device may be deemed incapable of processing a transaction if the device does not have such specialized software, hardware or security protocols. The platform may filter out devices deemed incapable of processing transactions and only rank or otherwise consider devices capable of processing transactions to serve as the transaction processing hub or device for the network. Additionally, or alternatively, the platform may filter out devices incapable of processing transactions from the polling process.

Once a transaction device is identified, devices in the network may be notified in step 225. By notifying devices in the network of the selected transaction device, a network device wishing to initiate a transaction will know where to send such requests for processing. In some arrangements, however, it might not be necessary to notify all devices or even any of the other devices in the network. For example, if the platform acts as an intermediary for all transaction requests, the platform might be the only device in the network that needs to know the identity of the transaction processing device.

The platform may determine, in step 230, whether the selected transaction device is available to perform a transaction. The platform may perform this check on the same or a different frequency (e.g., more frequent or less frequent) as the polling process. Since the transaction device has a particular responsibility (i.e., performing transactions for devices in the network), the monitoring of this transaction device may be, in some cases, more frequent than for other devices in the network. In some examples, the platform may check on the availability of the transaction processing device upon determining that a device in the network has initiated a transaction. The system may determine availability based on whether the transaction device responds to a request within a predefined amount of time or at all, whether the transaction device is still part of the network, and the like. Thus, if the device requesting a transaction does not receive a response within a specified amount of time, the requesting device may report the non-responsiveness to the device selection system for resolution. In another example, the transaction processing device may be tasked with reporting its availability to the platform periodically. If the platform does not receive a report at the expected time, the transaction processing device may be deemed unavailable. When a transaction processing device is determined to be unavailable, the device selection platform may select a new transaction device by executing the polling process (step 210), priority determination (step 215), and device selection (step 220) once again.

Beyond monitoring for the availability of the selected transaction processing device, the device selection system may also monitor the network based on a specified schedule or periodically using a timer in order to detect changes in the network in step 235. In one example, the device selection system may periodically poll the devices in the network to confirm that the device priorities have not changed. If they have (e.g., the currently-selected transaction device's processing load has suddenly increased, the device has increased cache space, the device has switched to battery power, etc.), the system may re-prioritize or re-rank the devices for selecting the transaction device for the network.

Additionally, or alternatively, the device selection platform may also be notified when there are changes to the network, such as changes in membership, in step 240. Changes in the network may be detected by messages from new devices wishing to join the network or current member devices exiting the network. In one example, a current member device leaving the network may be detected when that device fails to provide a scheduled or expected communication such as a periodic status update message or a message indicating it is still active in the network, and the like. Accordingly, if a device leaves the network or if a device joins the network, the device selection system may similarly re-execute the polling, ranking and selection processes to ensure that the most suitable device is acting as the transaction device. In one or more examples, the device selection system might not re-execute the polling and selection processes when a device, other than the currently-selected transaction device, leaves the network. If no changes in the network are detected in step 240, the process may return to step 230 where the platform monitors the availability of the transaction processing device.

As noted herein, the platform may also itself serve as a transaction processing device. In such a case, the platform may further perform a transaction execution step (not shown in FIG. 2), whereby the platform will extract transaction information from a transaction request and execute the transaction with a merchant through a payment channel. Transaction information may include merchant information (e.g., an identifier), a product identifier, a quantity, a payment amount, user information (e.g., authentication data such as a username and password), a payment account, and the like. Using this information, the platform may transmit corresponding requests to the vendor identifying the product, quantity and payment account, along with authentication information. In response, the platform may receive a confirmation which may be passed back to the device initiating the transaction.

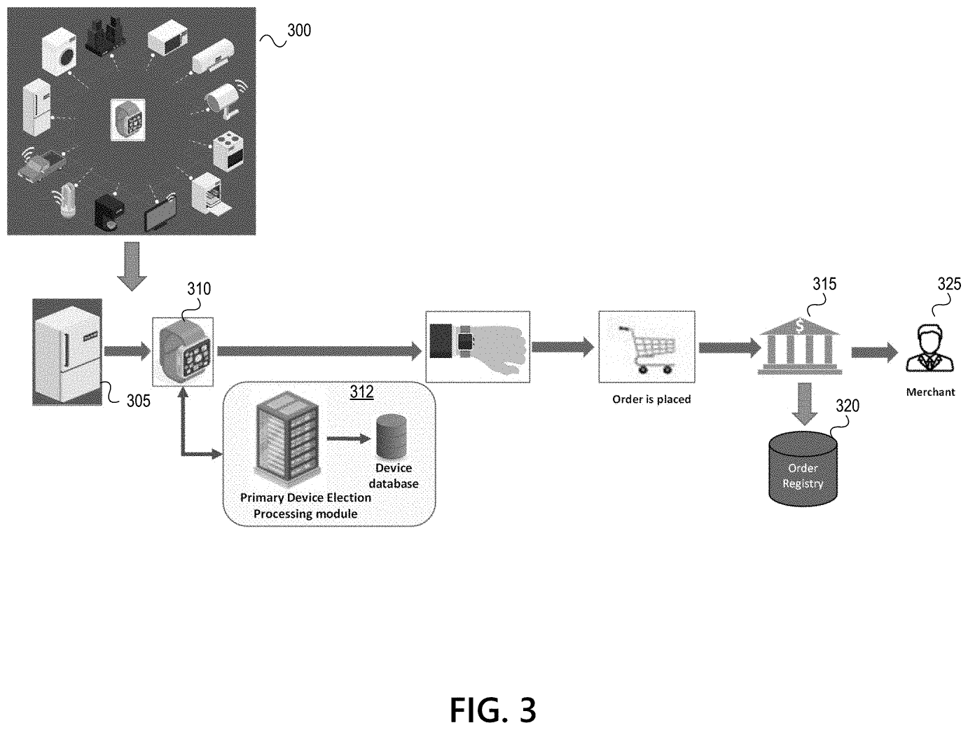

FIG. 3 is a diagram illustrating a transaction execution process for a network of devices such as an IoT network. In FIG. 3, IoT network 300 may include a variety of devices including a refrigerator, car, washing machine, dryer, television, speaker/stereo system, printer, security system (e.g., camera, microphone, etc.), lighting device, oven, microwave oven, and portable electronic devices (e.g., smart watch, tablet, mobile phone, etc.). These devices may share information to external devices as well as with one another. For example, a light fixture may inform a television that it has been turned off. The television may know that it is in the same location as the light fixture and automatically turn itself off or prompt a user to determine whether it should be turned off. In other examples, a vehicle may notify one or more devices in network 300 that it has left the location housing the network 300. This notification may trigger one or more device actions including a setting of the thermostat lower (or higher depending on the season), turning on of a security system, and the like. A variety of other data communications may occur between devices in an IoT network such as network 300.

As discussed, one or more devices within network 300 may initiate a transaction. For example, refrigerator 305 may initiate an order for more water filters. In another example, a thermostat may initiate a purchase for more air filters. When the one or more devices initiate a transaction, that transaction request may be sent to a selected primary transaction processing device. As discussed herein, the primary transaction processing device (or devices) may be selected based on a variety of factors. In FIG. 3, the selected transaction processing device is smartwatch 310. In one or more arrangements, when a transaction is initiated, a network host or managing system (i.e., device election processing platform 312 (e.g., implementing platform 110 of FIG. 1)) may confirm that the payment transaction device is available. If not, the network host or managing system may select a different device to serve as the payment transaction device for the network 300.

Once the transaction request is received, transaction processing device 310 may then execute the transaction by communicating the transaction details through a payment channel 315 (e.g., a financial institution holding a payment account or a payment network) which will subsequently send payment and transaction details to merchant 325. Alternatively, or additionally, the transaction processing device 310 may communicate directly with merchant 325. In one or more examples, the payment channel 310 may store transaction information for transactions it has processed into a registry 320. Confirmation that the order has been placed may be sent back to transaction processing device 310 and/or transaction initiating device 305.

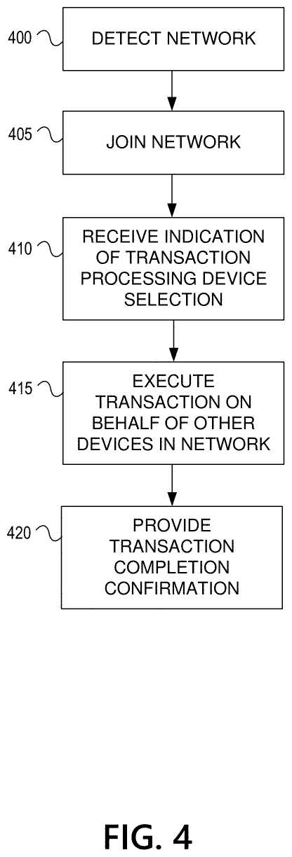

FIG. 4 is a flowchart illustrating a process by which a transaction processing device is selected for processing transaction requests within a network. In step 400, for example, a device may detect a network within its vicinity. The device may detect the network in a variety of ways including by receiving a broadcast message identifying the network to devices within a particular range of a network host and/or receiving network identification information from another device that is an existing member of the network. In step 405, the device may join the network. Joining the network may include providing a network manager with information about the device including power level, processing load, processing power, network connectivity, installed software, installed hardware, security protocols, memory capacity and the like. In step 410, the device may receive a message from a device selection system that it has been designated the transaction processing device for the network. This notification may include various information such as user information (e.g., payment account credentials, user's account credentials for merchants, etc.), default payment information (e.g., account information, credit card information, etc.), financial institution information, merchant information and the like. The notification may also provide transaction parameters such as spending limits, permitted types of transactions, permitted products, allowed times for transactions, and the like. In some arrangements, upon being notified of its selection, the device may execute certain processes or software for handling transaction processing in step 415. Additionally, or alternatively, the device may activate or otherwise configure secure communication channels for communicating transaction information. For example, the device may be configured to execute a virtual private network (VPN) and/or encrypt transaction information using a secure socket layer (SSL) protocol or the like. Upon completion of a transaction and/or completion of submission of a transaction, the processing device may provide a confirmation to the requesting or initiating device in step 420.

As discussed herein, the polling and device selection platform may serve as a transaction processing device. Accordingly, a polling and device selection platform may also perform one or more of the transaction processing steps of FIG. 4.

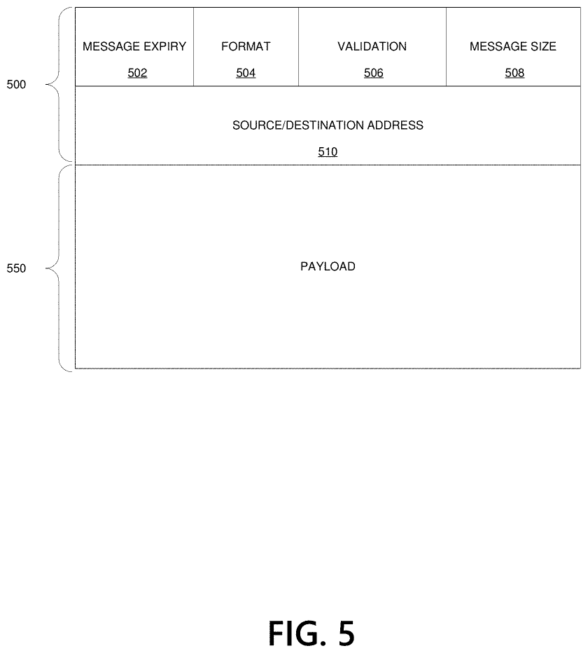

FIG. 5 illustrates an example packet structure for communications between devices in the network. Devices in the network may communicate with one another to provide status information, usage data, capability information, network connectivity status, transaction information, authentication information, network connection information and parameters, and the like. The packet structure may include packet header 500 storing various information and parameters such as message expiry 502, format 504, validation information 506, message size 508, and source and destination address information 510. Source and destination address information 510 may include a network or device identifier for the source of the message as well as a network or device identifier for the intended destination of that message. In some instances, messages may be communicated through intermediary devices. Accordingly, source and destination address information 510 may assist in routing the message to the correct destination and in identifying the original communication source. Message expiry 502 may indicate when the message is set to expire. For example, a message may include security information (e.g., codes, passwords, one-time keys) and/or transaction information that is only effective for a certain period of time. This message expiration may be defined by the source communication device or may be a default time period specific (e.g., specified by) the network.

Message header 500 may further include format 504 that specifies the format of the contents in the payload. For example, format 504 may indicate that the content of the payload is in JSON format or XML format. A variety of other message formats may be used and indicated in header section 504. Validation information 506 may provide communication security by storing a code or other security mechanism (hash, key, etc.) so that a destination or intermediary device can confirm that the message is authentic. In some cases, validation information 506 may include a device-specific validation code or identifier. Additionally, or alternatively, validation information 506 may include a key or code issued by a network host so that all communications can be verified as originating from an authorized source (e.g., a member of the network). In some examples, validation information 506 may, additionally or alternatively, include an error check code (e.g., CRC) to ensure that the message received does not include any errors. Similarly, message size 508 may indicate a size of the payload so that a destination device may confirm that the entirety of the message was received.

Payload 550 is configured to store the content of the communication or message. For a transaction request, for example, payload 550 may include a payment identifier (e.g., payment account number, payment account password), purchase cost, order expiration, discount codes, user identification, and the like and/or combination thereof. Payload 550 may also carry other types of information depending on the type of communication. For example, if a thermostat were to exchange user presence information with a security system, payload 550 may include a status indicator such as “away” or “home” as well as a time at which a change in status was detected. In another example, payload 550 may include network connectivity information when one or more of the devices in the network of devices joins or leaves another network (e.g., a LAN, the Internet or another WAN, a VPN, etc.).

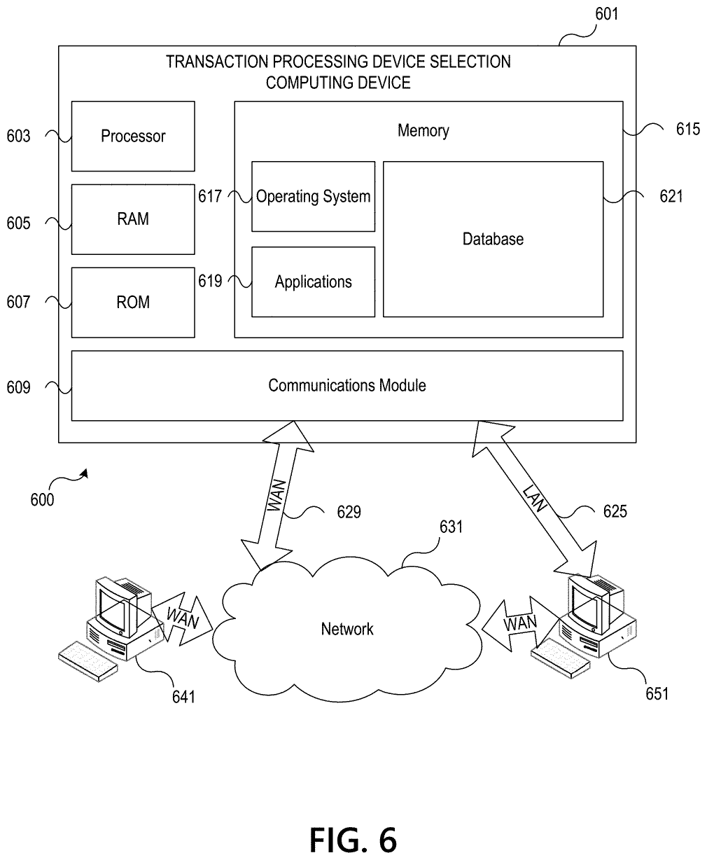

FIG. 6 depicts an illustrative operating environment in which various aspects of the present disclosure may be implemented in accordance with one or more example embodiments. The arrangements described with respect to FIG. 6 may be applied any devices shown and described herein. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include transaction processing device selection computing device 601 having processor 603 for controlling overall operation of transaction processing device selection computing device 601 and its associated components, including Random Access Memory (RAM) 605, Read-Only Memory (ROM) 607, communications module 609, and memory 615. Transaction processing device selection computing device 601 may include a variety of computer readable media. Computer readable media may be any available media that may be accessed by transaction processing device selection computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by transaction processing device selection computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on transaction processing device selection computing device 601. Such a processor may execute computer-executable instructions stored on a computer-readable medium.

Software may be stored within memory 615 and/or storage to provide instructions to processor 603 for enabling transaction processing device selection computing device 601 to perform various functions as discussed herein. For example, memory 615 may store software used by transaction processing device selection computing device 601, such as operating system 617, application programs 619, and associated database 621. Also, some or all of the computer executable instructions for transaction processing device selection computing device 601 may be embodied in hardware or firmware. Although not shown, RAM 605 may include one or more applications representing the application data stored in RAM 605 while transaction processing device selection computing device 601 is on and corresponding software applications (e.g., software tasks) are running on transaction processing device selection computing device 601.

Communications module 609 may include a microphone, keypad, touch screen, and/or stylus through which a user of transaction processing device selection computing device 601 may provide input, and may also include one or more of a speaker for providing audio output and a video display device for providing textual, audiovisual and/or graphical output. Computing system environment 600 may also include optical scanners (not shown).

Transaction processing device selection computing device 601 may operate in a networked environment supporting connections to one or more remote computing devices, such as computing devices 641 and 651. Computing devices 641 and 651 may be personal computing devices or servers that include any or all of the elements described above relative to transaction processing device selection computing device 601.

The network connections depicted in FIG. 6 may include Local Area Network (LAN) 625 and Wide Area Network (WAN) 629, as well as other networks. When used in a LAN networking environment, transaction processing device selection computing device 601 may be connected to LAN 625 through a network interface or adapter in communications module 609. When used in a WAN networking environment, transaction processing device selection computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method for dynamically selecting a processing device in a network, the method comprising:
identifying, by a computing device over computer network, a plurality of devices currently connected to the network;
obtaining, by the computing device, device attributes for the plurality of devices connected to the network;
determining, by the computing device, a priority value for each of the plurality of devices based on the obtained device attributes;
selecting, by the computing device, at least a first device of the plurality of devices to operate as a transaction processing device for transaction requests initiated by each of the other devices of the plurality of devices.

2. The method of claim 1, further comprising:
communicating the selection of the first device as the transaction processing device to each of the other devices of the plurality of devices.

3. The method of claim 1, wherein the device attributes including at least one of: device battery life, device processing load, device processing power, and device storage capacity.

4. The method of claim 3, wherein determining the priority value for each of the plurality of values includes:
determining a first priority value for each of the plurality of values based on a first device attribute;
determining a second priority value for each of the plurality of devices based on a second device attribute; and
determining a total priority value by combining the first priority value and the second priority value.

5. The method of claim 1, further comprising:
upon detecting a transaction initiation by one of the plurality of devices, determining whether the selected first device is available; and
in response to determining that the selected first device is not available, selecting a second device of the plurality of devices to serve as the transaction processing device for the network.

6. The method of claim 5, wherein selecting the second device includes:
obtaining, by the computing device after determining the first device is unavailable, updated device attributes for the plurality of devices connected to the network; and
determining, by the computing device, updated priority value for each of the plurality of devices based on the obtained device attributes; and
selecting the second device based on the updated priority values.

7. The method of claim 1, further comprising:
determining whether a specified condition has been satisfied; and
in response to determining that specified condition has been satisfied, selecting a second device of the plurality of devices to serve as the transaction processing device for the network, wherein selecting the second device includes:
obtaining, by the computing device after determining the specified condition has been satisfied, updated device attributes for the plurality of devices connected to the network; and
determining, by the computing device, updated priority value for each of the plurality of devices based on the obtained device attributes; and
selecting the second device based on the updated priority values.

8. An apparatus comprising:
a processor; and
memory storing computer readable instructions that, when executed, cause the apparatus to:
identify, over computer network, a plurality of devices currently connected to the network;
obtain device attributes for the plurality of devices connected to the network;
determine a priority value for each of the plurality of devices based on the obtained device attributes;
select at least a first device of the plurality of devices to operate as a transaction processing device for transaction requests initiated by each of the other devices of the plurality of devices.

9. The apparatus of claim 8, wherein the computer readable instructions, when executed, further cause the apparatus to:
communicate the selection of the first device as the transaction processing device to each of the other devices of the plurality of devices.

10. The apparatus of claim 8, wherein the device attributes including at least one of: device battery life, device processing load, device processing power, and device storage capacity.

11. The apparatus of claim 10, wherein determining the priority value for each of the plurality of values includes:
determining a first priority value for each of the plurality of values based on a first device attribute;
determining a second priority value for each of the plurality of devices based on a second device attribute; and
determining a total priority value by combining the first priority value and the second priority value.

12. The apparatus of claim 8, wherein the computer readable instructions, when executed, further cause the apparatus to:
upon detecting a transaction initiation by one of the plurality of devices, determine whether the selected first device is available; and
in response to determining that the selected first device is not available, select a second device of the plurality of devices to serve as the transaction processing device for the network.

13. The apparatus of claim 12, wherein selecting the second device includes:
obtaining, after determining the first device is unavailable, updated device attributes for the plurality of devices connected to the network; and
determining updated priority value for each of the plurality of devices based on the obtained device attributes; and
selecting the second device based on the updated priority values.

14. The apparatus of claim 8, wherein the computer readable instructions, when executed, further cause the apparatus to:
determine whether a specified condition has been satisfied; and
in response to determining that specified condition has been satisfied, select a second device of the plurality of devices to serve as the transaction processing device for the network, wherein selecting the second device includes:
obtaining, after determining the specified condition has been satisfied, updated device attributes for the plurality of devices connected to the network; and
determining updated priority value for each of the plurality of devices based on the obtained device attributes; and
selecting the second device based on the updated priority values.

15. A computer readable medium storing computer readable instructions that, when executed, cause a transaction processing device selection apparatus to:
identify, over computer network, a plurality of devices currently connected to the network;
obtain device attributes for the plurality of devices connected to the network;
determine a priority value for each of the plurality of devices based on the obtained device attributes; and
select at least a first device of the plurality of devices to operate as a transaction processing device for transaction requests initiated by each of the other devices of the plurality of devices.

16. The computer readable medium of claim 15, wherein the device attributes including at least one of: device battery life, device processing load, device processing power, and device storage capacity.

17. The computer readable medium of claim 16, wherein determining the priority value for each of the plurality of values includes:
determining a first priority value for each of the plurality of values based on a first device attribute;
determining a second priority value for each of the plurality of devices based on a second device attribute; and
determining a total priority value by combining the first priority value and the second priority value.

18. The computer readable medium of claim 15, wherein the computer readable instructions, when executed, further cause the apparatus to:
upon detecting a transaction initiation by one of the plurality of devices, determine whether the selected first device is available; and
in response to determining that the selected first device is not available, select a second device of the plurality of devices to serve as the transaction processing device for the network.

19. The computer readable medium of claim 18, wherein selecting the second device includes:
obtaining, after determining the first device is unavailable, updated device attributes for the plurality of devices connected to the network; and
determining updated priority value for each of the plurality of devices based on the obtained device attributes; and
selecting the second device based on the updated priority values.

20. The computer readable medium of claim 15, wherein the computer readable instructions, when executed, further cause the apparatus to:
determine whether a specified condition has been satisfied; and
in response to determining that specified condition has been satisfied, select a second device of the plurality of devices to serve as the transaction processing device for the network, wherein selecting the second device includes:
obtaining, after determining the specified condition has been satisfied, updated device attributes for the plurality of devices connected to the network; and
determining updated priority value for each of the plurality of devices based on the obtained device attributes; and
selecting the second device based on the updated priority values.
